(19) United States
(12) Patent Application Publication
(10) Pub. No.: US 2017/0182786 A1
(43) Pub. Date: Jun. 29, 2017

(54) ENCAPSULANTS TO RETAIN WIRES AT BOND PADS

(71) Applicant: HEWLETT-PACKARD DEVELOPMENT COMPANY, LP., Houston, TX (US)

(72) Inventors: Emilio Angulo Navarro, Sant Cugat del Valles (ES); Josiah CHAN, Singapore (SG); Fernando Bayona Alcolea, Barcelona (ES); Albert Crespi Serrano, Barcelona (ES); Mikel Zuza Irurueta, Barcelona (ES); Jorge Castano, Barcelona (ES); Ying Ying HO, Singapore (SG)

(73) Assignee: HEWLETT-PACKARD DEVELOPMENT COMPANY, LP., Houston, TX (US)

(21) Appl. No.: 15/116,026

(22) PCT Filed: Feb. 4, 2014
(86) PCT No.: PCT/US2014/014552

§ 371 Date: Aug. 2, 2016

(51) Int. Cl. B41J 2/175

(52) U.S. Cl. CPC B41J 2/17566; B41J 2002/17579

(57) ABSTRACT

An example device in accordance with an aspect of the present disclosure includes a sensor die having a sensitive region and a bond pad. A bond is formed between a wire and the bond pad of the sensor die. An encapsulant is to retain the wire at the bond pad and mechanically support the wire and the bond, based on covering the bond and wire according to an encapsulant height, extending from the bond pad, greater than a bond height. The encapsulant is localized at the bond pad of the sensor die to enable the sensitive region to remain uncovered by the encapsulant.

### BACKGROUND

An inkjet printer may interface with an embedded sensor within a disposable inkjet cartridge to determine ink levels. The embedded sensor is disposed along with the inkjet cartridge, and does not operate beyond the life of the disposable inkjet cartridge.

### BRIEF DESCRIPTION OF THE DRAWINGS/FIGURES

FIG. 1A is a top view block diagram of a device including a sensor die according to an example.

FIG. 1B is a side view block diagram of a device including a sensor die according to an example.

FIG. 2 is a block diagram of a printer including a sensor die according to an example.

FIG. 3 is a block diagram of a sensor die including an encapsulant according to an example.

FIG. 4 is a flow chart based on encapsulating a bond according to an example.

### DETAILED DESCRIPTION

Examples described herein enable robust sensor(s) to be located in a printer (e.g., located at an ink channel of the printer), to detect ink levels of replaceable ink cartridges. Accordingly, ink cartridges do not need to include their own embedded pressure sensor, reducing overall system costs over the life of the printer (e.g., throughout multiple replacements of the ink cartridge). A sensor installed in the printer may, be exposed to operating environmental conditions (humidity, contamination, and oxidation) over a much longer life cycle of the printer, needing much higher robustness and reliability. In contrast, sensors embedded in inkjet cartridges do not operate beyond a life cycle of the disposable inkjet cartridge, and would degrade, suffer open circuits, and other faults rendering the sensor useless if not for the short ink cartridge life cycle. In an example sensor disclosed herein, encapsulant may be selectively applied to a sensor die and related elements to, e.g., improve the reliability of the bond between wires and silicon pads of the sensor die, to increase structural/mechanical strength and corrosion resistance and ensure appropriate reliability throughout the life of the printer over several years in operational conditions. Furthermore, the encapsulant is applied to avoid covering a sensitive region of the sensor die.

Example sensors and related components may receive selective encapsulation, in contrast to being fully encapsulated. A portion of example sensors/sensor dies described herein include a sensitive region to serve as a measuring device, to remain exposed for sensing without being covered by encapsulant. Selective encapsulation of the wires, bonds, bond pads, and other components associated with the sensor addresses operating concerns and extends the life of the sensor significantly, without negatively affecting operation of the sensor.

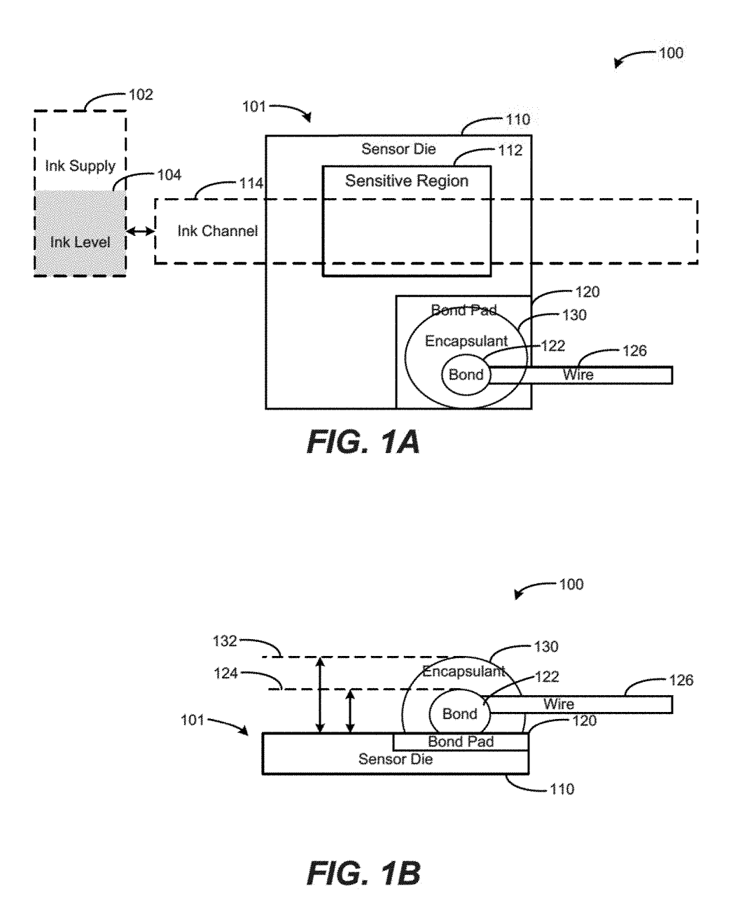

FIG. 1A is a top view block diagram of a device 100 including a sensor die 110 according to an example. The sensor die 110 includes a sensitive region 112 that is coupleable to an ink channel 114 of a printer. An ink supply 102 is coupleable to the ink channel 114. The sensitive region 112 is to identify an ink level 104 of the ink supply 102. The sensor die 110 includes a bond pad 120. A wire 126 is coupled to the bond pad 120 based on bond 122. Encapsulant 130 is to encapsulate at least a portion of the wire 126, bond 122, and/or bond pad 120.

In operation, the device 110 may be exposed to environmental conditions associated with degradation. For example, ink from the ink supply 102 may pass through the ink channel 114, and pass across the sensor die 110, sensitive region 112 bond pad 120, bond 122, and wire 126. Thus, such components may be exposed to moisture, changing temperatures, and jostling movement caused by printing motions of the device 100. Accordingly, components of device 100 are exposed to conditions that would normally encourage chemical degradation as well as mechanical degradation, which may damage or otherwise cause open circuits between the wire 126 and the sensor die 110. Encapsulant 130 is to protect the various components from such threats, while allowing the sensitive region 112 to operate.

The sensor die 110, and/or sensitive region 112, may be referred to herein as a sensor 101. For example, the sensor 101 may sense differences in pressure between an air pressure (e.g., experienced by an exterior of an ink bag of the ink supply 102) and an ink pressure (e.g., experienced by ink inside the ink bag of the ink supply 102). The sensor 101 may be used to check the ink level 104 corresponding to an amount of remaining ink. Sensed information from the sensor 101 may be passed to a printer controller via the wire 126 that is bonded to the sensor 101.

The sensitive region 112 of the sensor 101 may be provided as a bare portion of silicon on the sensor die 110, where deformation of the silicon provides a signal to sense the pressure to be measured. In alternate examples, other types of sensors may be used. Reliability of the sensor 101 can depend on how robustly the wires 126 are bonded to the sensor 101, to communicate effectively with the sensor die 110 of the device 100.

The sensor 101 may include at least one bond pad 120, to enable communication with the sensor 101 and allow physical attachment of the wires 126. The bond pad 120 may be made of a conductive material, including metals and non-metals such as aluminum, gold, platinum, copper, graphene, and so on. In an example, the bond pad 120 may be a first metal, different than a second metal used for the wire 126. More specifically, the bond pad 120 may be aluminum associated with manufacturing of the sensor die 110, and the wire 126 may be gold, associated with bonding temperatures to avoid subjecting heat-stress to the device 100 associated with the gold wires 126 being bonded to the aluminum bond pads 120. Using other materials, such as copper for example, may increase heat exposure and risk damage from the higher temperatures to bond such metal.

The bond 122 may form in response to the wire 126 being attached to the bond pad 120, and may form as a ball/sphere (a bond ball). The bond 122 may be formed even if the wire 126 and the bond pad 120 are of different materials. If using different metals, an intermetallic compound (IMC) may form at the bond 122. Use of different materials can affect the formation of IMC, e.g., where bonds between copper and aluminum form less IMC than bonds between gold and aluminum. Materials may be chosen to be conducive to bonding in view of fragility of the sensor 101, to avoid heating damage associated with forming the bond 122. Bonding gold and aluminum results in IMC formation, which may degrade the strength (physical and electrical) of the bond 122. Encapsulant 130 may be applied to the bond 122.

The encapsulant 130 may be localized at the bond 122 to avoid covering the sensitive region 112 of the sensor 101. The encapsulant 130 is shown having an oval shape, and alternate examples may be provided in any desirable shape. The encapsulant 130 may be applied on top of the bond 122, to cover a bond ball associated with the bond 122. The encapsulant 130 may be applied directly to the bond 122 without a need for additional processes such as the introduction of a forming wall or dam to support, shape, and/or receive the encapsulant 130. This is because the encapsulant 130 may be a viscous gel that is to hold its shape and avoid spreading out like a liquid film. Thus, the encapsulant 130 may be associated with a viscosity and/or surface tension to prevent flowing away from an area to be encapsulated, without risk of covering the sensitive region 112 (or uncovering the bond 122 by falling below a bond height). In an example, the encapsulant 130 may be a UV curable optical epoxy such as EPO-TEC® OG116-31. The encapsulant 130 may be transparent, to enable visual inspection of the bond 122, wire 126, the bond pad 120, and other underlying components covered by the encapsulant 130.

The encapsulant 130 may protect the chemical formation of the IMC, i.e., the new component formed between gold and the aluminum (or other dissimilar metals) used in the wire 126 and bond pad 120. The encapsulant 130 is to be formed to provide robustness against oxidation from moisture, and to mechanically reinforce the bond 122 and prevent it from becoming weaker in view of mechanical and chemical environmental factors. The encapsulant 130 may enclose a portion of the wire 126 with the bond 122 and bond pad 120, to help mechanically stabilize the wire 126 to the bond pad 120. Thus, the encapsulant 130 is to provide structural/mechanical support, protect from oxidation caused by water, oxygen, or other external environmental factors, and also stabilize and prevent degradation/disconnection from metal phase change chemical reactions between wire 126 and bond pad 120 (e.g., IMC formation between different metals). Accordingly, encapsulant 130 may avoid mechanical stress weakening, corrosion, and other degenerative processes, protecting the desired area where the bond 122 is located, while leaving the sensitive region 112 of the sensor 101 uncovered for accurate sensing.

FIG. 1B is a side view block diagram of a device 100 including a sensor die 110 according to an example. Wire 126 is bonded to the bond pad 120 of the sensor die 110 via bond 122. Encapsulant 130 is to encapsulate at least a portion of the wire 126, bond 122, and/or bond pad 120. The bond 122 is associated with a bond height 124, and the encapsulant 130 is associated with an encapsulant height 132.

The encapsulant 130 is shown in contact with a large proportion of the bond pad 120, enabling a strong mechanical attachment of the encapsulant for mechanical support to the bond 122 and wire 126 (based on the encapsulant 130 also enveloping the bond 122 and at least a portion of the wire 126). In an alternate example, the encapsulant 130 may extend beyond the bond pad 120, to also contact the sensor die 110 for additional mechanical support from the sensor die 110. The encapsulant 130 also may extend down an edge of the sensor 101, to provide lateral support across the bond pad 120 and/or the sensor die 110.

The encapsulant 130 is associated with an encapsulant height 132 relative to the sensor die and/or bond pad. The bond 122 is associated with a bond height 124 relative to the sensor die and/or bond pad. The bond pad 120 itself may vary in height relative to the sensor die 110, but is shown at the same level as the sensor die 110 for simplicity. However, the various heights may occur relative to the sensor die 110 or the bond pad 120 as appropriate. The encapsulant 130 is associated with a viscosity and/or surface tension to prevent the encapsulant height 132 from falling below the bond height 124 prior to hardening of the encapsulant 130. Accordingly, the bond 122 is fully covered by the encapsulant 130, ensuring mechanical and chemical isolation of the bond 122 from environmental conditions. Similarly, a width of the encapsulant 130 may be varied, to exceed the width of the bond 122 and/or the bond pad 120. Furthermore, the encapsulant 130 may be associated with a convex external curvature enabling the encapsulant 130 to extend along the wire 126 beyond an edge of the sensor die 110 and/or bond pad 120, providing enhanced mechanical support to the wire 126.

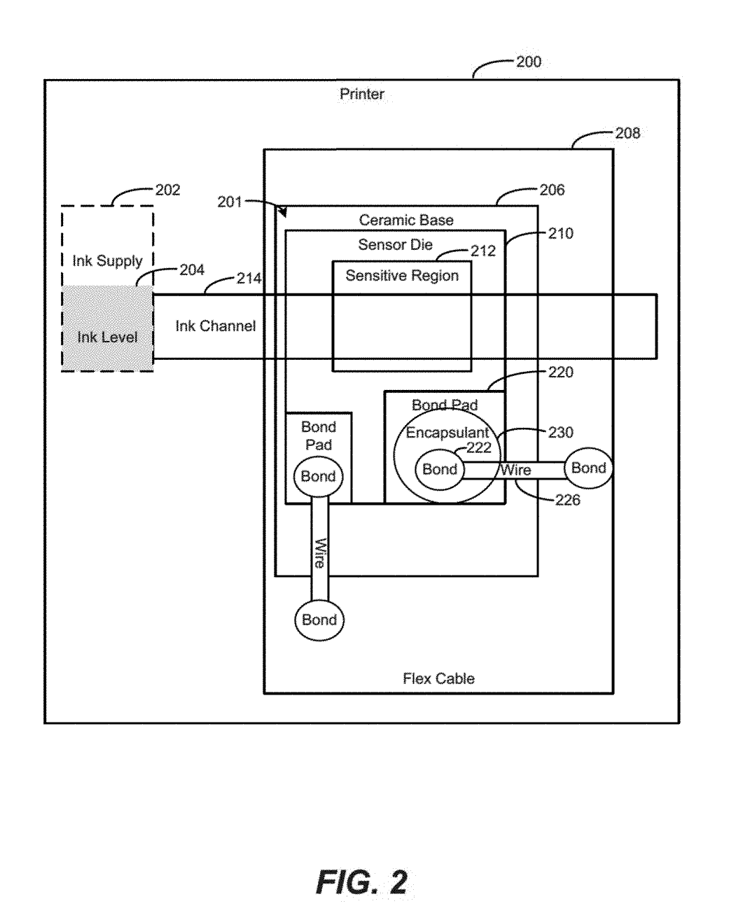

FIG. 2 is a block diagram of a printer 200 including a sensor die 210 according to an example. The printer 200 includes a flex cable 208 to communicate with the sensor die 210. The sensor die 210 and/or sensitive region 212 may be referred to as sensor 201. The sensor die 210 may be mounted to a ceramic base 206, and coupled to the flex cable 208 via wires 226 bonded or otherwise coupled to communicate with the flex cable 208. The sensor die 210 includes sensitive region 212 coupled to ink channel 214. An ink supply 202, associated with an ink level 204, is coupleable to the ink channel 214. The sensor die 210 includes a bond pad 220. Wire 226 is coupled to the bond pad 220 based on bond 222. Encapsulant 230 is to encapsulate at least a portion of the wire 226. bond 222, and/or bond pad 220.

The printer 200 may communicate with the sensor 201 via the flex cable 208. For example, the sensor 201 may be located in a sealed pressure box of the printer 200, with the flex cable 208 emerging from the pressure box to carry signals between the sensor 201 and the printer 200. Wires are shown bonded to the flex cable, without encapsulant 230 on those flex cable bonds. However, the flex cable may contain traces that are of the same material as the wire, thereby avoiding formation of IMC. Furthermore, portions of the flex cable 208 are not subject to the same stresses and degrading factors that the sensor 201 is exposed to. However, in alternate examples, the flex cable bonds may receive encapsulant.

The flex cable 208 may support the ceramic base 206, e.g., based on gluing or otherwise mounting/integrating the ceramic base 206 to the flex cable 208. The ceramic base 206 may support the sensor die 210, e.g., based on the sensor die 210 being glued or otherwise mounted/integrated to the ceramic base 206. The flex cable 208 may include bond pads or other features, such as a flex circuit having electrical traces, to electrically connect with other elements of the printer 200. In an example, the flex cable may include gold bond pads and/or traces, to bond with gold wires, and avoid formation of IMC at the flex cable bonds.

The encapsulant 230 is shown disposed on a first bond pad 220 of the sensor 201, while not being disposed on a second bond pad of the sensor 201. Selective application of the encapsulant 230 enables some bonds of the sensor 201 to be encapsulated, without a need to have all bonds encapsulated. In an example, the first bond pad 220 may be associated with a metal, such as aluminum, different than the metal of wire 226, such as gold, resulting in IMC formation to be encapsulated. In contrast, the second bond pad may be wired using the same metal as the bond pad, such that no IMC forms and the resulting bond is not encapsulated. Thus, example devices, such as device 200, enable a sensor 201 to include a combination of non-encapsulated and encapsulated bond pads 220, with encapsulant 230 selectively applied as desired.

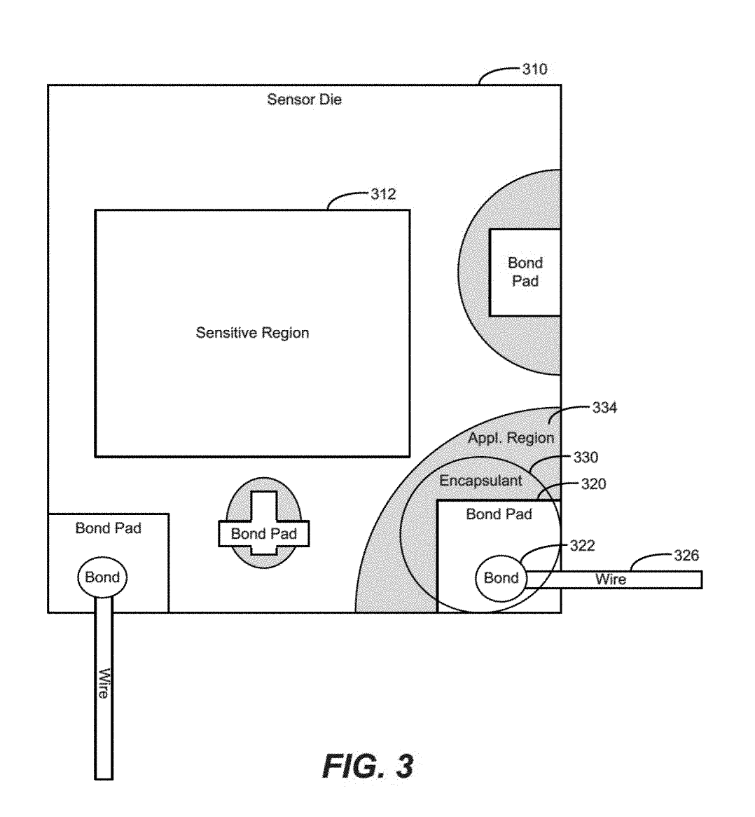

FIG. 3 is a block diagram of a sensor die 310 including an encapsulant 330 according to an example. The sensor die 310 includes sensitive region 312 and a plurality of bond pads 320. Wire 326 is coupled to the bond pad 320 based on bond 322. Encapsulant 330 is to encapsulate at least a portion of the wire 326, bond 322, and/or bond pad 320. Application region 334 is to identify in which region of the sensor die 310 the encapsulant 330 is to be applied.

Bond pads 320 may be distributed in various locations on the sensor die 310, including at corners, edges (e.g., away from a corner), and areas not at an edge or a corner. Bond pads 320 may, or may not, be bonded to a wire 326. Bond pads 320 that are bonded to a wire may, or may not, include encapsulant 330. In an example, a bond pad that is not bonded to a wire also may be covered with encapsulant, e.g., to isolate the bond pad, even though the bond pad is not currently being used by a wire. A bond pad may be needed to serve as a grounding contact, or perhaps may be needed in the future to be bonded to a wire and encapsulated. Thus, device 310 enables encapsulant 330 to be selectively applied to different areas over time, without a need for encapsulant 330 to be applied to the plurality of bond pads 320 simultaneously. Bond pads 320 may be located at a periphery of the sensitive region 312, such that the encapsulant 330 does not cover the sensitive region 312.

The sensor die 310 may be associated with at least one application region 334. The application region 334 is to identify a region of the sensor die 310 in which encapsulant 330 is to be applied. Conversely, regions of the sensor die 310 not covered by an application region 334 are not to receive application of encapsulant 330. An application region 334 may be associated with a corresponding bond pad 320. The application region 334 may be specified to describe a geometric shape, such as a semicircle, quarter circle, oval, and so on. The application region 334 may fully enclose a corresponding bond pad 320, and also may cover a portion of the bond pad (with other portions of the bond pad not being covered by the application region).

The encapsulant 330 is to fully cover the bond 322, to provide mechanical strength and protection to the bond 322. Encapsulant 330 may be placed/dropped very precisely onto the sensor die 310 according to the application region 334, without a need to use a dam or other form to prevent the encapsulant 330 from flowing onto undesirable regions (such as the sensitive region 312) prior to hardening. Accordingly, example devices may precisely define the application regions 334 to describe any shape, including geometric shapes such as squares, rectangles, triangles, and so on, as well as non-geometric, irregular, or other shapes. The application region 334 may be specified to cover only a portion of a bond pad 320, and may address bond pads having irregular shapes that may or may not correspond to a shape of the associated application region 334 for that bond pad 320. In an example, the application region 334 may be fully contained within the bounds of a bond pad 320, without extending beyond a boundary of the bond pad 320. A given application region 334 may correspond to multiple bonds 322. For example, one application region 334 may extend across two bond pads 320. Thus, in an example, a single drop application of encapsulant 330 may be applied along an edge of the sensor die 310, to spread across multiple bonds 322 along that edge. Similarly, multiple drops of encapsulant 330 may be applied near each other to form into a single region of encapsulant 330. Any number of drops of encapsulant 330 may be applied and combined on sensor die 310.

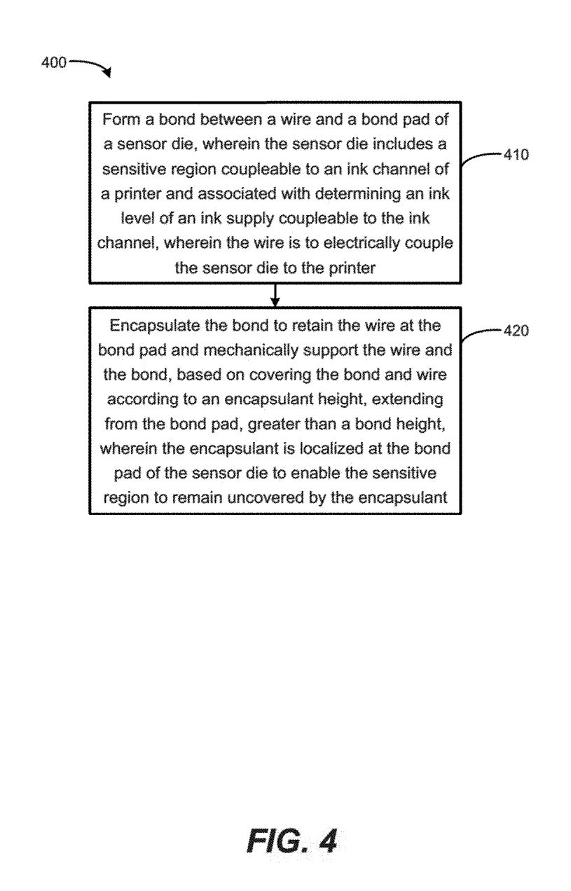

Referring to FIG. 4, a flow diagram is illustrated in accordance with various examples of the present disclosure. The flow diagram represents processes that may be utilized in conjunction with various systems and devices as discussed with reference to the preceding figures. While illustrated in a particular order, the disclosure is not intended to be so limited. Rather, it is expressly contemplated that various processes may occur in different orders and/or simultaneously with other processes than those illustrated.

FIG. 4 is a flow chart 400 based on encapsulating a bond according to an example. In step 410, a bond is formed between a wire and a bond pad of a sensor die. The sensor die includes a sensitive region coupleable to an ink channel of a printer and associated with determining an ink level of an ink supply coupleable to the ink channel. The wire is to electrically couple the sensor die to the printer. In an example, the wire and bond pad are different materials that result in a fragile bond, corresponding to a delicate wire, that are subject to jarring motions caused by a carriage of an inkjet printer. In step 420, the bond is encapsulated to retain the wire at the bond pad and mechanically support the wire and the bond, based on covering the bond and wire according to an encapsulant height, extending from the bond pad, greater than a bond height. The encapsulant is localized at the bond pad of the sensor die to enable the sensitive region to remain uncovered by the encapsulant. In an example, an encapsulant is applied to the completed bond based on drop application, to fully cover the bond and at least a portion of the bond pad and wire. Accordingly, the hardened encapsulant may provide mechanical support to the bond, wire, sensor die, and bond pad, as well as protecting against the effects of other environmental conditions such as moisture and the formation of intermetallic compounds.

What is claimed is:

1. A device comprising:
a sensor die, including a sensitive region and a bond pad, wherein the sensitive region is coupleable to an ink channel of a printer and associated with determining an ink level of an ink supply coupleable to the ink channel;
a wire to electrically couple the sensor die to the printer;
a bond formed between the wire and the bond pad of the sensor die; and
an encapsulant to retain the wire at the bond pad and mechanically support the wire and the bond, based on covering the bond and wire according to an encapsulant height, extending from the bond pad, greater than a bond height, wherein the encapsulant is localized at the bond pad of the sensor die to enable the sensitive region to remain uncovered by the encapsulant.

2. The device of claim 1, wherein the bond includes a bond ball, wherein the encapsulant is to structurally maintain continuity of the bond in the presence of degradation of the bond ball.

3. The device of claim 2, wherein the bond ball includes phase change degradation based on formation of an intermetallic compound (IMC) from a reaction between dissimilar materials of the wire and bond pad.

4. The device of claim 1, wherein the wire is a first conductive material and the bond pad is a second conductive material different than the first conductive material.

5. The device of claim 1, wherein the encapsulant is an epoxy having a viscosity and surface tension to prevent the encapsulant height from falling below the bond height prior to hardening of the encapsulant.

6. The device of claim 1, wherein the encapsulant is transparent.

7. The device of claim 1, wherein the sensor die includes an application region to receive the encapsulant localized at the bond pad, wherein the application region extends beyond the bond pad without overlapping the sensitive region.

8. The device of claim 7, wherein the bond pad is located at a periphery of the sensitive region, and the application region extends away from the sensitive region.

9. The device of claim 7, wherein the bond pad is located away from a corner of the sensor die at a periphery of the sensitive region, and the application region extends away from the sensitive region.

10. The device of claim 7, further comprising an uncovered bond pad and associated uncovered wire and uncovered bond, wherein the application region of the sensor die does not overlap the uncovered bond pad.

11. A printer comprising:
an ink channel to couple the printer to an ink supply;
a sensor die including a sensitive region and a bond pad, wherein the sensitive region is in fluid communication with the ink channel to determine an ink level of the ink supply;
a wire to electrically couple the sensor die to the printer;
a bond formed between the wire and the bond pad of the sensor die; and
an encapsulant to retain the wire at the bond pad and mechanically support the wire and the bond, based on covering the bond and wire according to an encapsulant height, extending from the bond pad, greater than a bond height, wherein the encapsulant is localized at the bond pad of the sensor die to enable the sensitive region to remain uncovered by the encapsulant.

12. The printer of claim 11, further comprising a flex cable, wherein the wire is bonded to the flex cable to couple the wire from the sensor die to the printer.

13. The printer of claim 12, further comprising a ceramic base to mount the sensor die, wherein the ceramic base is mounted to the flex cable.

14. A method, comprising:
forming a bond between a wire and a bond pad of a sensor die, wherein the sensor die includes a sensitive region coupleable to an ink channel of a printer and associated with determining an ink level of an ink supply coupleable to the ink channel, wherein the wire is to electrically couple the sensor die to the printer; and
encapsulating the bond to retain the wire at the bond pad and mechanically support the wire and the bond, based on covering the bond and wire according to an encapsulant height, extending from the bond pad, greater than a bond height, wherein the encapsulant is localized at the bond pad of the sensor die to enable the sensitive region to remain uncovered by the encapsulant.

15. The method of claim 14, further comprising bonding the wire to a flex cable of the printer, to couple the wire from the sensor die to the printer.
